(19) United States
(12) Patent Application Publication
(10) Pub. No.: US 2013/0068134 A1
(43) Pub. Date: Mar. 21, 2013

(54) Oxidized Alpha Olefins

(71) Applicants: Hu YANG, Manvel, TX (US); Eduardo J. BARALT, Kingwood, TX (US); Steven HUTCHISON, Spring, TX (US)

(72) Inventors: Hu YANG, Manvel, TX (US); Eduardo J. BARALT, Kingwood, TX (US); Steven HUTCHISON, Spring, TX (US)

(73) Assignee: CHEVRON PHILLIPS CHEMICAL COMPANY LP, The Woodlands, TX (US)

(21) Appl. No.: 13/235,204

(22) Filed: Sep. 16, 2011

(51) Int. Cl. C08L 91/00

(52) U.S. Cl. 106/270

(57) ABSTRACT

A method comprising contacting an olefin wax with an oxidizing agent to produce an oxidized olefin wax, contacting the oxidized olefin wax with an odor-reducing material to produce an odor-reduced oxidized olefin wax, and removing water from the odor-reduced oxidized olefin wax. A composition comprising a product of a mixture of an oxidized olefin wax and an odor-reducing material, wherein the needle penetration of the composition is less than the oxidized alpha olefin wax in the absence of the odor-reducing material.

### FIELD

The present disclosure relates generally to hydrocarbon waxes. More specifically, the present disclosure relates to methods of preparing oxidized hydrocarbon waxes that have improved hardness and/or viscosity and reduced odor.

### BACKGROUND

Hydrocarbon waxes, such as alpha olefin waxes, paraffin waxes, microcrystalline waxes, polyethylene waxes, and Fisher-Tropsch waxes, can be characterized by a set of basic physical property parameters, which are used to predict or correlate performance in specific applications. Two of the most commonly cited wax physical properties are hardness and viscosity. The hardness of waxes is one of the most important performance criteria in applications such as polishing (e.g., floor, furniture, and automobile), coating (e.g., textile, fruit, paper), candle formulation, investment casting, and a range of industrial composite structures. It would be desirable to improve the physical strength of alpha olefin waxes for improved performance in current applications or use in applications for which they have not yet been suitable. Further, it would be desirable if an improvement in physical strength could be achieved with minimal impact on the low melt viscosity of the alpha olefin waxes. A low melt viscosity can be a highly desirable process characteristic for any hydrocarbon wax to ensure adequate flow during the processing stage in many applications. It is well known that a range of hydrocarbon waxes can be oxidized into functional waxes by reacting oxygen or oxygen-containing gas with waxes at elevated temperatures. The oxidation changes the chemical compositions via a free-radical mechanism, which converts hydrocarbon wax molecules into esters and acids, among other oxygen containing compounds (e.g., alcohols and aldehydes, among others). The resulting oxidized waxes can be suitable for a range of specific applications where high polarity and/or functionality can be required. Many applications can require a substantial oxidation of the non-polar hydrocarbon waxes. As a result, many processes have been developed for maximizing the oxidation efficiency for a high level of oxidation. These processes can include use of an autoclave reactor in a batch process, or a reaction column or tubular reactor in a continuous process. The typical saponification numbers of oxidized waxes can be similar to those of natural waxes. For example, the typical saponification numbers of oxidized waxes can be in the range of 50-150 mg KOH per g, and typical acid numbers can be in the range of 30-50 mg KOH per g.

For some specialty applications, oxidized waxes are desirable, as described in U.S. Pat. Nos. 3,901,789; 3,994,737; 4,004,932; 4,180,408; 4,240,795; 4,426,229; 6,169,148 and 6,348,547. However, oxidation of hydrocarbon waxes can generally lead to compromised physical properties, such as higher viscosity, as well as discoloration from white to undesirably non-white color.

Furthermore, a range of hydrocarbon waxes can be oxidized to impart functionality to the waxes. However, the oxidized waxes often can have a characteristic rancid odor. Thus, it can be desirable to suppress such an odor for the practical applications of these oxidized waxes.

### SUMMARY

Disclosed herein is a method comprising contacting an olefin wax with an oxidizing agent to produce an oxidized olefin wax, contacting the oxidized olefin wax with an odor-reducing material to produce an odor-reduced oxidized olefin wax, and removing water from the odor-reduced oxidized olefin wax.

Also disclosed herein is a composition comprising a product of a mixture of an oxidized olefin wax and an odor-reducing material, wherein the needle penetration of the composition is less than the oxidized alpha olefin wax in the absence of the odor-reducing material.

Further disclosed herein is a method comprising i) contacting an olefin wax with an oxidizing agent to produce an oxidized olefin wax under conditions capable of forming an oxidized olefin wax, ii) contacting the oxidized olefin wax with an odor-reducing material to produce an odor-reduced olefin wax under conditions capable of forming an odor-reduced oxidized olefin wax; and iii) removing water from the odor-reduced oxidized olefin wax. In an embodiment, a condition capable of forming an oxidized olefin wax can comprise a temperature ranging from the olefin wax melting point to 300° C. In an embodiment, the oxidized olefin wax can have a kinematic viscosity at 100° C. less than 70 cSt; or alternatively, a kinematic viscosity at 100° C. of up to about 500% greater than the kinematic viscosity of the olefin wax. In an embodiment, the oxidized olefin wax can have a needle penetration value at 25° C. at least 5 percent less than a needle penetration value at 25° C. In yet other embodiments, the oxidized olefin wax can have a drop melt point greater than the drop melt point of the olefin wax. In an embodiment, a condition capable of forming an odor-reduced oxidized olefin wax can comprise a temperature ranging from the oxidized olefin wax melting point to 300° C. In an embodiment, a condition capable of forming an odor-reduced oxidized olefin wax can comprise removing water from the odor-reduced oxidized olefin wax. In an embodiment, the odor-reduced oxidized olefin wax can have a 25° C. needle penetration value less than the 25° C. needle penetration of the oxidized olefin wax in the absence of the odor-reducing material; or alternatively, the odor-reduced oxidized olefin wax can have a needle penetration value at 25° C. at least 10 percent less than a needle penetration value at 25° C. of the oxidized alpha olefin wax in the absence of the odor-reducing material. In some embodiments, the odor-reduced oxidized olefin wax can have a 100° C. kinematic viscosity ranging from 5 cSt to 200 cSt. In other embodiments, the odor-reduced oxidized olefin wax can have a drop melt point greater than the drop melt point of the oxidized olefin wax in the absence of the odor-reducing material.

### DETAILED DESCRIPTION

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2^{nd} Ed (1997) can be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

Groups of elements of the table are indicated using the numbering scheme indicated in the version of the periodic table of elements published in Chemical and Engineering News, 63(5), 27, 1985. In some instances, a group of elements can be indicated using a common name assigned to the group; for example alkali earth metals (or alkali metals) for Group 1 elements, alkaline earth metals (or alkaline metals) for Group 2 elements, transition metals for Group 3-12 elements, and halogens for Group 17 elements.

Regarding claim transitional terms or phrases, the transitional term “comprising”, which is synonymous with “including,” “containing,” “having,” or “characterized by,” is inclusive or open-ended and does not exclude additional, unrecited elements or method steps. The transitional phrase “consisting of” excludes any element, step, or ingredient not specified in the claim. The transitional phrase “consisting essentially of” limits the scope of a claim to the specified materials or steps and those that do not materially affect the basic and novel characteristic(s) of the claimed invention. A “consisting essentially of” claim occupies a middle ground between closed claims that are written in a “consisting of” format and fully open claims that are drafted in a “comprising” format. Absent an indication to the contrary, when describing a compound or composition “consisting essentially of” is not to be construed as “comprising,” but is intended to describe the recited component that includes materials which do not significantly alter the composition or method to which the term is applied. For example, a feedstock consisting of a material A can include impurities typically present in a commercially produced or commercially available sample of the recited compound or composition. When a claim includes different features and/or feature classes (for example, a method step, feedstock features, and/or product features, among other possibilities), the transitional terms comprising, consisting essentially of, and consisting of apply only to the feature class which is utilized and it is possible to have different transitional terms or phrases utilized with different features within a claim. For example, a method can comprise several recited steps (and other non-recited steps) but utilize a catalyst system preparation consisting of specific or alternatively, consist of specific steps and/or utilize a catalyst system comprising recited components and other non-recited components.

Within this disclosure, use of “comprising” or an equivalent expression contemplates the use of the phrase “consisting essentially of,” “consists essentially of,” or equivalent expressions as an alternative embodiments to the open-ended expression. Additionally, use of “comprising” or an equivalent expression or use of “consisting essentially of” in the specification contemplates the use of the phrase “consisting of,” “consists of,” or equivalent expression as an alternative to the open-ended expression or middle ground expression, respectively. For example, “comprising” should be understood to include “consisting essentially of,” and “consisting of” as alternative embodiments for the aspect, features, and/or elements presented in the specification unless specifically indicated otherwise.

The terms “a,” “an,” and “the” are intended, unless specifically indicated otherwise, to include plural alternatives, e.g., at least one. For instance, the disclosure of “a normal alpha olefin” is meant to encompass one normal alpha olefin, or mixtures or combinations of more than one normal alpha olefin unless otherwise specified.

The term “hydrocarbon” whenever used in this specification and claims refers to a compound containing only carbon and hydrogen. A “paraffin” whenever used in this specification and claims refers to a saturated “hydrocarbon.”

The term “wax” whenever used in this specification and claims refers to an organic material having a melting point greater than 35° C. at 1 atmosphere. The term “wax composition” whenever used in this specification and claims refers to a composition comprising a wax or wax molecules. The term “wax composition” can refer to a composition comprising, consisting essentially of, or consisting of, a wax or wax molecules. Compounds which are not wax molecules (e.g. solvents and additives, among others) can be present in a “wax composition” comprising a wax. The term “hydrocarbon wax” whenever used in this specification and claims refers to wax molecules which are hydrocarbons; i.e., hydrocarbon wax molecules. The term “hydrocarbon wax composition” whenever used in this specification and claims refers to a composition comprising hydrocarbon wax molecules. Compounds which are not a hydrocarbon wax molecule (e.g., solvents, and/or non-hydrocarbon and/or non-wax impurities, among others) can be present in the “hydrocarbon wax composition” or a “hydrocarbon wax composition comprising a hydrocarbon wax” unless otherwise indicated. Hydrocarbon wax compositions comprising, consisting essentially of, or consisting of, a hydrocarbon wax refer to compositions consistent with the definitions of hydrocarbon wax, comprising, consisting essentially of, and consisting of, as provided herein. The term “olefin wax” whenever used in this specification and claims refers to wax molecules which are olefinic. The term “olefin wax composition” whenever used in this specification and claims refers to a compositions comprising olefin wax molecules. Compounds which are not an olefin wax molecule (e.g., solvents, and/or non-olefin and/or non-wax impurities, among others) can be present in the “olefin wax composition.” Olefin wax compositions comprising, consisting essentially of, or consisting of, a hydrocarbon wax refer to compositions consistent with the definitions of olefin wax, comprising, consisting essentially of, and consisting of as provided herein. Other waxes, wax molecules, and/or wax compositions can be readily envisioned using other descriptors or combinations of descriptors and would conform to same use patterns.

The term “olefin” whenever used in this specification and claims refers to compounds that have at least one carbon-carbon double bond that is not part of an aromatic ring or ring system. The term “olefin” includes aliphatic and aromatic, cyclic and cyclic, and/or linear and branched compounds having at least one carbon-carbon double bond that is not part of an aromatic ring or ring system unless specifically stated otherwise. The term “olefin,” by itself, does not indicate the presence or absence of heteroatoms and/or the presence or absence of other carbon-carbon double bonds unless explicitly indicated. Olefins having only one, only two, only three, etc. . . . carbon-carbon double bonds can be identified by use of the term “mono,” “di,” “tri,” etc. . . . within the name of the olefin. The olefins can be further identified by the position of the carbon-carbon double bond(s).

The term “alkene” whenever used in this specification and claims refers to a hydrocarbon olefin that has at least one non-aromatic carbon-carbon double bond. The term “alkene” includes aliphatic or aromatic (an alkene having an aromatic substituent within the compound), cyclic or acyclic, and/or linear and branched compounds having at least one non-aromatic carbon-carbon double bond unless expressly stated otherwise. Alkenes having only one, only two, only three, etc. . . . such multiple bond can be identified by use of the term “mono,” “di,” “tri,” etc. . . . within the name. For example, alkamonoenes, alkadienes, and alkatrienes refer to a linear or branched hydrocarbon olefins having only one carbon-carbon double bond (general formula CₙH₂ₙ), only two carbon-carbon double bonds (general formula CnH₂ₙ₋₂), and only three carbon-carbon double bonds (general formula CₙH₂ₙ₋₄), respectively. Alkenes can be further identified by the position of the carbon-carbon double bond(s). Other identifiers can be utilized to indicate the presence or absence of particular groups within an alkene. For example, a haloalkene refers to an alkene having one or more hydrogen atoms replace with a halogen atom.

The term “alpha olefin” as used in this specification and claims refers to an olefin that has a double bond between the first and second carbon atom of the longest contiguous chain of carbon atoms. The term “alpha olefin” includes linear and branched alpha olefins unless expressly stated otherwise. In the case of branched alpha olefins, a branch can be at the 2-position (a vinylidene) and/or the 3-position or higher with respect to the olefin double bond. The term “vinylidene” whenever used in this specification and claims refers to an alpha olefin having a branch at the 2-position with respect to the olefin double bond. By itself, the term “alpha olefin” does not indicate the presence or absence of heteroatoms and/or the presence or absence of other carbon-carbon double bonds unless explicitly indicated. The terms “hydrocarbon alpha olefin” or “alpha olefin hydrocarbon” refer to alpha olefin compounds containing only hydrogen and carbon.

The term “linear alpha olefin” as used herein refers to a linear olefin having a double bond between the first and second carbon atom. The term “linear alpha olefin” by itself does not indicate the presence or absence of heteroatoms and/or the presence or absence of other carbon-carbon double bonds, unless explicitly indicated. The terms “linear hydrocarbon alpha olefin” or “linear alpha olefin hydrocarbon” refers to linear alpha olefin compounds containing only hydrogen and carbon.

The term “normal alpha olefin” whenever used in this specification and claims refers to a linear hydrocarbon mono-olefin having a double bond between the first and second carbon atom. It is noted that “normal alpha olefin” is not synonymous with “linear alpha olefin” as the term “linear alpha olefin” can include linear olefinic compounds having a double bond between the first and second carbon atoms and having heteroatoms and/or additional double bonds.

Acid number values, when referred to herein, were measured according to ASTM D974-07, unless explicitly stated to the contrary, and refers to the number of milligrams of potassium hydroxide (KOH) required to neutralize one gram material. Saponification numbers, when referred to herein, were measured by ASTM D94-07, unless explicitly stated to the contrary, and refers to the number of milligrams of potassium hydroxide (KOH) required to saponify 1 g of material. Needle penetrations when referred to herein, were measured according to ASTM D1321-86, unless explicitly stated to the contrary. Drop melt points, when referred to herein, were measured according to ASTM D127-87, unless explicitly stated to the contrary. All kinematic viscosities are the 100° C. kinematic viscosities as measured by ASTM D445-96, unless explicitly stated to the contrary. All ASTM standards referred to herein are the most current versions as of the filing date of the present application.

In an aspect, the present disclosure describes compositions comprising an oxidized olefin wax compositions having a reduced odor. In an embodiment, the composition (e.g., an odor-reduced oxidized olefin wax) can comprise, or consist essentially of, a) an oxidized olefin wax and an odor-reducing material, b) an oxidized olefin wax and a reaction product of a component of the oxidized olefin wax and the odor-reducing material, or c) an oxidized olefin wax, a reaction product of a component of the oxidized olefin wax and the odor-reducing material, and an odor-reducing material. In another embodiment, the composition (e.g., an odor-reduced oxidized olefin wax) can comprise a product of a mixture of an oxidized olefin wax and an odor-reducing material. In some embodiments, odor-reduced oxidized olefin wax composition can have desirable properties; e.g., needle penetration, drop melt point, and/or 100° C. kinematic viscosity, among other properties. Generally, the oxidized olefin wax, the olefin from which the oxidized olefin, the odor-reducing material, the quantity of odor-reducing material, and the properties of the odor-reduced oxidized olefin wax composition are independent features of the odor-reduced oxidized olefin wax composition. These independent features of the odor-reduced oxidized olefin wax composition are independently described herein and the odor-reduced oxidized olefin wax composition can be described utilizing any combination of these independent features. Additionally, independently described aspects and embodiments relating to the olefin wax utilized to produce the oxidized olefin wax, the method utilized to produced the oxidized olefin, and/or the method utilized to produce the odor-reduced oxidized olefin wax composition can be utilized to further describe the odor-reduced olefin wax composition.

In an aspect, the present disclosure relates to a method to produce an odor-reduced oxidized olefin wax (or odor-reduced oxidized olefin wax composition). In an embodiment, the method can comprise i) contacting an olefin wax with an oxidizing agent to produce an oxidized olefin wax and ii) contacting the oxidized olefin wax with an odor-reducing material to produce an odor-reduced olefin wax. Generally, the olefin wax, the oxidizing agent, the conditions and/or method by which the olefin wax and oxidizing agent can be contacted, the conditions under which the oxidized olefin wax can be produced, the odor-reducing material, the conditions and/or method by which the oxidized olefin wax and the oxidizing material can be contacted, the conditions under which the odor-reduced oxidized olefin wax can be produced, and other method steps which can be utilized in the method are independent features of the method. These independent features are independently described herein and can be utilized in any combination to describe the method.

Generally, the olefin wax can comprise, or consist essentially of, any olefin having at least 20 carbon atoms. In an embodiment, the olefin can comprise, or consist essentially of, an internal olefin, an alpha olefin, or any combination thereof; alternatively, an internal olefin; or alternatively, an alpha olefin. In some embodiments, the olefins of the olefin wax (e.g., internal olefin and/or alpha olefin) can comprise, or consist essentially of, linear olefins, branched olefins, or any combination thereof; alternatively, a linear olefin; or alternatively, a branched olefin. In other embodiments, the olefin wax can comprise, or consist essentially of, linear internal olefins; alternatively, linear alpha olefins. In yet other embodiments, the olefin wax can comprise a normal alpha olefin. In an embodiment, the olefin wax can comprise a mixture of one or more olefins selected from the group consisting of linear alpha olefins, linear internal olefins, branched alpha olefins, and branched internal olefins. In some embodiments, the olefin wax (regardless of whether it comprises linear or branched olefins and/or alpha olefin or internal olefins) can comprise, or consist essentially of, hydrocarbon olefins. Additional criteria which can be independently utilized, either singly or in any combination, to describe the olefin wax can include the olefin content, paraffin content, average olefin molecular weight, carbon number composition, alpha olefin content, internal olefin content, linear internal olefin content, vinylidene and olefin content, among other properties disclosed herein. The olefin wax which can be oxidized can be referred to as a feedstock olefin wax.

In an aspect, the olefin wax can comprise greater than or equal to 35 mole percent olefins; alternatively, greater than or equal to 45 mole percent olefins; alternatively, greater than or equal to 50 mole percent olefins; alternatively, greater than or equal to 60 mole percent olefins; alternatively, greater than or equal to 70 mole percent olefins; alternatively, greater than or equal to 75 mole percent olefins; alternatively, greater than or equal to 85 mole percent olefins; alternatively, greater than or equal to 90 mole percent olefins; or alternatively, greater than or equal to 95 mole percent olefins. In an aspect, the olefin wax can comprise greater than or equal to 35 weight percent olefins; alternatively, greater than or equal to 45 weight percent olefins; alternatively, greater than or equal to 50 weight percent olefins; alternatively, greater than or equal to 60 weight percent olefins; alternatively, greater than or equal to 70 weight percent olefins; alternatively, greater than or equal to 75 weight percent olefins; alternatively, greater than or equal to 85 weight percent olefins; alternatively, greater than or equal to 90 weight percent olefins; or alternatively, greater than or equal to 95 weight percent olefins. Generally, the quantity of olefins (in either weight or mole percent) in the olefin wax is based upon the entire amount of olefin wax (weight or number of moles).

In an embodiment, the olefin wax can contain less than 65 mole percent paraffin; alternatively, less than 50 mole percent paraffin; alternatively, less than 35 mole percent paraffin; alternatively, less than 20 mole percent paraffin; alternatively, less than 8 mole percent paraffin; or alternatively, less than 5 mole percent paraffin. In another embodiment, the olefin wax can contain less than 65 weight percent paraffin; alternatively, less than 50 weight percent paraffin; alternatively, less than 35 weight percent paraffin; alternatively, less than 20 weight percent paraffin; alternatively, less than 8 weight percent paraffin; or alternatively, less than 5 weight percent paraffin. Generally, the paraffin content of the olefin wax (in either weight or mole percent) is based upon the entire amount of olefin wax (weight or number of moles).

In an embodiment, the olefin wax can comprise olefins having at least 20 carbon atoms per olefin molecule; alternatively, at least 24 carbon atoms per olefin molecule; alternatively, at least 26 carbon atoms per olefin molecule; alternatively, at least 28 carbon atoms per olefin molecule; or alternatively, at least 30 carbon atoms per olefin molecule. In another embodiment, the olefin wax can comprise olefins having from 20 carbon atoms per olefin molecule to 30 carbon atoms per olefin molecule; alternatively, having from 20 carbon atoms per olefin molecule to 24 carbon atoms per olefin molecule; alternatively, having from 24 carbon atoms per olefin molecule to 28 carbon atoms per olefin molecule; or alternatively, having from 26 to 28 carbon atoms per olefin molecule. In an embodiment, the paraffin which can be present in the olefin wax can have the same carbon number(s) (or carbon number ranges) as recited for the olefins of the olefin wax.

The olefin wax can comprise olefins having various carbon numbers, as described herein. In an embodiment, the olefins of the olefin wax can comprise greater than 30 mole percent olefins having any herein recited number of carbon atoms; alternatively, greater than 45 mole percent olefins having any herein recited number of carbon atoms; alternatively, greater than 50 mole percent olefins having any herein recited number of carbon atoms; alternatively, greater than 60 mole percent olefins having any herein recited number of carbon atoms; alternatively, greater than 70 mole percent olefins having any herein recited number of carbon atoms; alternatively, greater than 75 mole percent olefins having any herein recited number of carbon atoms; alternatively, greater than 80 mole percent olefins having any herein recited number of carbon atoms; alternatively, greater than 85 mole percent olefins having any herein recited number of carbon atoms; alternatively, greater than 90 mole percent olefins having any herein recited number of carbon atoms; or alternatively, greater than 95 mole percent olefins having any herein recited number of carbon atoms. In other embodiments, the olefins of the olefin wax can comprise greater than 50 weight percent olefins having any herein recited number of carbon atoms; alternatively, greater than 60 weight percent olefins having any herein recited number of carbon atoms; alternatively, greater than 70 weight percent olefins having any herein recited number of carbon atoms; alternatively, greater than 80 weight percent olefins having any herein recited number of carbon atoms; alternatively, greater than 85 weight percent olefins having any herein recited number of carbon atoms; alternatively, greater than 90 weight percent olefins having any herein recited number of carbon atoms; or alternatively, greater than 95 weight percent olefins having any herein recited number of carbon atoms. In yet another embodiment, the olefin wax can consist essentially of olefins having any herein recited number of (or range of) carbon atoms.

In a non-limiting embodiment, the olefin wax can comprise greater than or equal to 70 weight percent, 80 weight percent, 85 weight percent, 90 weight percent, or 95 weight percent olefins having greater than or equal to 20 carbon atoms. In some non-limiting embodiments, the olefin wax can comprise greater than or equal to 70 weight percent, 80 weight percent, 85 weight percent, 90 weight percent, or 95 weight percent olefins having from 20 to 30 carbon atoms. In other non-limiting embodiments, the olefin wax can comprise greater than or equal to 70 weight percent, 80 weight percent, 85 weight percent, 90 weight percent, or 95 weight percent olefins having from 20 to 24 carbon atoms. In some other non-limiting embodiments, the olefin wax can comprise greater than or equal to 50 weight percent, 60 weight percent, 70 weight percent, 80 weight percent, or 90 weight percent olefins having from 24 to 28 carbon atoms. In yet other non-limiting embodiments, the olefin wax can comprise greater than or equal to 50 weight percent, 60 weight percent, 70 weight percent, 80 weight percent, or 90 weight percent olefins having from 26 to 28 carbon atoms. In further non-limiting embodiments, the olefin wax can comprise greater than or equal to 70 weight percent, 80 weight percent, 90 weight percent, or 95 weight percent olefins having greater than or equal to 30 carbon atoms. Other combinations of olefin contents and carbon number values or ranges are readily apparent from aspects and embodiments described in the present disclosure.

Independent of the mole percentage or weight percentage of olefins having a particular carbon number (or range of carbon numbers), the olefins of the olefin wax can further comprise a percentage of a particular olefin (e.g., linear olefin, branched olefin, internal olefin, linear internal olefin, branched internal olefin, alpha olefin, linear alpha olefin, branched alpha olefin, normal alpha olefin, or combinations thereof).

In an embodiment, the olefin wax can comprise alpha olefins. In some embodiments, the olefins of the olefin wax can comprise at least 30 mole percent alpha olefins; alternatively, at least 45 mole percent alpha olefins; alternatively, at least 60 mole percent alpha olefins; alternatively, at least 75 mole percent alpha olefins; alternatively, at least 90 mole percent alpha olefins; or alternatively, at least 95 mole percent alpha olefins. In some embodiments, the olefins of the olefin wax can comprise from 50 to 99 mole percent alpha olefins; alternatively, from 55 to 98 mole percent alpha olefins; alternatively, from 60 to 97 mole percent alpha olefins; or alternatively, from 65 to 95 mole percent alpha olefins.

In an embodiment, the olefin wax can comprise linear alpha olefins. In some embodiments, the olefins of the olefin wax can comprise at least 30 mole percent linear alpha olefins; alternatively, at least 45 mole percent linear alpha olefins; alternatively, at least 60 mole percent linear alpha olefins; alternatively, at least 75 mole percent linear alpha olefins; alternatively, at least 90 mole percent linear alpha olefins; or alternatively, at least 95 mole percent linear alpha olefins. In some embodiments, the olefins of the olefin wax can comprise from 50 to 99 mole percent liner alpha olefins; alternatively, from 55 to 98 mole percent alpha olefins; alternatively, from 60 to 97 mole percent linear alpha olefins; or alternatively, from 65 to 95 mole percent linear alpha olefins.

In an embodiment, the olefin wax can comprise normal alpha olefins. In some embodiments, the olefins of the olefin wax can comprise at least 30 mole percent normal alpha olefins; alternatively, at least 45 mole percent normal alpha olefins; alternatively, at least 60 mole percent normal alpha olefins; alternatively, at least 75 mole percent normal alpha olefins; alternatively, at least 90 mole percent normal alpha olefins; or alternatively, at least 95 mole percent normal alpha olefins. In some embodiments, the olefins of the olefin wax can comprise from 50 to 99 mole percent normal alpha olefins; alternatively, from 55 to 98 mole percent normal alpha olefins; alternatively, from 60 to 97 mole percent normal alpha olefins; or alternatively, from 65 to 95 mole percent normal alpha olefins.

In an embodiment, the olefin wax can comprise vinylidenes. In some embodiments, the olefins of the olefin wax can comprise from 2 to 90 mole percent vinylidenes; alternatively, from 4 to 80 mole percent vinylidenes; or alternatively, 6 to 60 mole percent vinylidenes. In other embodiments, the olefins of the olefin wax can comprise from 4 to 20 mole percent vinylidenes; alternatively, from 5 to 18 mole percent vinylidenes; alternatively, from 6 to 15 mole percent vinylidenes; alternatively, from 7 to 25 mole percent vinylidenes; alternatively, from 9 to 20 mole percent vinylidenes; alternatively, from 11 to 17 mole percent vinylidenes; alternatively, from 10 to 30 mole percent vinylidenes; alternatively, from 12 to 18 mole percent vinylidenes; alternatively, from 15 to 25 mole percent vinylidenes; alternatively, from 20 to 65 mole percent vinylidenes; alternatively, from 22 to 60 mole percent vinylidenes; alternatively, from 25 to 55 mole percent vinylidenes; or alternatively, from 25 to 45 mole percent vinylidenes.

Generally, the carbon number of the alpha olefins (general, linear, or normal) and/or vinylidenes present in the olefins of the olefin wax can be any carbon number disclosed herein for the olefins of the olefin wax.

Generally, the olefin wax can be described using any percentage of olefins present in the olefin wax in combination with any percentage of any particular olefin type (or olefin types such that the total of the olefin types do not total over 100 percent). Additionally, other olefin wax properties described herein can be utilized to further describe the olefin wax. In a non-limiting embodiment, the olefin wax can comprise at least 90 weight percent olefins having from 20 to 24 carbon atoms and the olefins of the olefin wax can comprise at least 75 mole percent normal alpha olefins having from 20 to 24 carbon atoms; alternatively, the olefin wax can comprise at least 70 weight percent olefins having from 24 to 28 carbon atoms and the olefins of the olefin wax can comprise at least 45 mole percent normal alpha olefins having from 24 to 28 carbon atoms; alternatively, the olefin wax can comprise at least 90 weight percent olefins having from 26 to 28 carbon atoms and at least 75 mole percent normal alpha olefins having from 26 to 28 carbon atoms; alternatively, the olefin wax can comprise at least 80 weight percent olefins having at least 30 carbon atoms and the olefin of the olefin wax can comprise at least 45 mole percent normal alpha olefins having at least 30 carbon atoms; or alternatively, the olefin wax can comprise at least 85 weight percent olefins having at least 30 carbon atoms and the olefin of the olefin wax can comprise at least 75 mole percent normal alpha olefins having at least 30 carbon atoms. Other combinations of the percentage of olefin present in the olefin wax and the percentage of a particular olefin type are readily apparent from the present disclosure.

In an embodiment, the olefin wax can have a particular average molecular weight. In an embodiment, the olefin wax can have an average molecular weight of at least 210 grams per mole; alternatively, at least 240 grams per mole; alternatively, at least 260 grams per mole; alternatively, at least 330 grams per mole; or alternatively, at least 450 grams per mole. In some embodiments, the olefin wax can have an average molecular weight ranging from 210 grams per mole to 550 grams per mole; alternatively, ranging from 240 grams per mole to 500 grams per mole; or alternatively, ranging from 270 grams per mole to 450 grams per mole. In other embodiments, the olefin wax can have an average molecular weight ranging from 210 grams per mole to 390 grams per mole; alternatively, ranging from 260 grams per mole to 340 grams per mole; alternatively, ranging from 280 grams per mole to 320 grams per mole; or alternatively, ranging from 285 grams per mole to 310 grams per mole. In another embodiment, the olefin wax can have an average molecular weight ranging from 330 grams per mole to 420 grams per mole; alternatively, ranging from 350 grams per mole to 400 grams per mole; or alternatively, ranging from 360 grams per mole to 390 grams per mole. In yet another embodiment, the olefin wax can have an average molecular weight ranging from 440 grams per mole to 550 grams per mole; alternatively, ranging from 460 grams per mole to 530 grams per mole; or alternatively, ranging from 480 grams per mole to 510 grams per mole. In further embodiments, the olefin wax can have an average molecular weight ranging from 480 grams per mole to 700 grams per mole; alternatively, ranging from 500 grams per mole to 640 grams per mole; or alternatively, ranging from 500 grams per mole to 580 grams per mole.

Commercially available olefin waxes commonly contain a number of alpha olefins having at least about 20 carbon atoms per olefin molecule as well as other compounds (such as for example, smaller alpha olefins, smaller normal alpha olefins, internal olefins, vinylidene, or others). For example, Alpha Olefin C₂₀₋₂₄ (available from Chevron Phillips Chemical Company LP, The Woodlands, Tex.) can comprise about 35-55 wt % C₂₀ olefin, about 25-45 wt % C₂₂ olefin, about 10-26 wt % C₂₄ olefin, about 3 wt % olefins smaller than C₂₀, and about 2 wt % olefins larger than C₂₄. Alpha Olefin C₂₀₋₂₄ is an exemplary olefin wax within the definition “comprising an olefin having at least 20 carbon atoms per olefin molecule” as used herein. The disclosure is not limited to this or any other particular commercially available olefin wax. Also, an olefin wax consisting essentially of an olefin having 20 carbon atoms per olefin molecule (or another olefin having a particular number of carbon atoms per olefin molecule greater than 20) can be used herein.

Commercially available olefin waxes can further comprise vinylidene or internal olefins, up to as much as about 40-50 wt % of the olefin wax. In one embodiment, and regardless of the number of carbons in the olefin, the olefin wax is a high alpha (HA) alpha olefin wax. By “HA wax” is meant a wax comprising (a) one or more alpha olefins and (b) less than about 20 wt % vinylidene or internal olefins.

In an embodiment, the olefin wax can have a saponification number less than 5 mg KOH per gram (“g’) olefin wax, 2.5 mg KOH per g olefin wax, or 1 mg KOH per g olefin wax. In an embodiment, the olefin wax can have an acid number less than 5 mg KOH per g olefin wax, 2.5 mg KOH per g olefin wax, 1 mg KOH per g olefin wax, or 0.5 mg KOH per g olefin wax.

Olefin waxes which can be utilized as the olefin wax can include olefin streams from ethylene oligomerization, cracked heavy waxes (e.g. Fischer-Tropsch waxes), and mixtures of paraffins and olefins, among others. In an embodiment, the olefin wax can be a Fischer-Tropsch wax comprising a mixture of paraffin waxes and olefin waxes which meet the described herein olefin wax features. One source of commercially available Fischer-Tropsch waxes is Sasol, Johannesburg, South Africa.

In some embodiments, the olefin wax can comprise, or consist essentially of, commercially available normal alpha olefin waxes. One source of commercially available alpha olefin waxes is Chevron Phillips Chemical Company LP, The Woodlands, Tex. Table 1 provides physical and chemical characteristics of the normal alpha olefin waxes AlphaPlus® C20-24, AlphaPlus® C24-28, AlphaPlus® C26-28, AlphaPlus® C30+, and AlphaPlus® C30+HA, which are provided for illustrative purposes as exemplary olefin waxes. The disclosure is not limited to these particular olefin waxes.

TABLE 1
Typical Properties for AlphaPlus ® Olefin Waxes

| | Typical Value (Typical Range) | | | | |
|---|---|---|---|---|---|
| | AlphaPlus ® | AlphaPlus ® | AlphaPlus ® | AlphaPlus ® | AlphaPlus ® |
| Characteristic | C20-24 | C24-28 | C26-28 | C30+ | C30+HA |
| ≦C₁₈ (wt %) | 0.6 | | | | |
| C₂₀-C₂₄ (wt %) | 98.6 | | | | |
| ≧C₂₆ (wt %) | 0.8 | | | | |
| ≦C₂₂ (wt %) | | 0.4 | | | |
| C₂₄-C₂₈ (wt %) | | 70.8 | | | |
| ≧C₃₀ (wt %) | | 18.8 | | | |
| ≦C₂₄ (wt %) | | | 1.2 | | |
| C₂₆-C₂₈ (wt %) | | | 96.2 | | |
| ≧C₃₀ (wt %) | | | 2.6 | | |
| ≦C₂₈ (wt %) | | | | 11.4 | 4.5 |
| ≧C₃₀ (wt %) | | | | 88.6 | 95.5 |
| Mole % Alpha Olefins | 86 | 54 | 79 | 62 | 76 |
| (¹H-NMR) | (83-92) | (40-60) | (70-82) | (50-65) | (70-81) |
| Mole % Vinylidenes | 8 | 30 | 16 | 30 | 18 |
| (¹H-NMR) | (6-15) | (25-55) | (11-20) | (25-45) | (15-25) |
| Mole % Internal olefins | 3 | 18 | 3 | 10 | 5.3 |
| (¹H-NMR) | (2-5) | (10-22) | (2-8) | (5-20) | (4-10) |
| Drop melt point, ° F. | 96 | 151 | 125 | 162 | 159 |
| (ASTM D 127) | | (140-158) | (122-130) | (154-174) | (150-164) |
| Oil content (MEK | | 3.7 | 4.6 | 1.9 | 1.5 |
| extraction), wt. % | | (3.0-5.1) | (3.2-6.0) | (1.0-3.0) | (1.0-3.0) |
| Needle Penetration | 150 | 59 | 48 | 13 | 15.5 |
| @77° F., dmm | | (48-70) | (40-60) | (11-17) | (12-18) |
| Needle Penetration | | | | 24 | 32 |
| @ 100° F., dmm | | | | (18-30) | (24-44) |
| Needle Penetration | | | | 34 | 40 |
| @ 110° F., dmm | | | | (25-50) | (30-56) |
| Flash Point | 362° F. | 425° F. | 417° F. | 485° F. | 432° F. |
| (ASTM D 93) | (183° C.) | (218° C.) | (214° C.) | (252° C.) | (222° C.) |
| Saybolt Color | 30 | 25 | 30 | 20+ | 20+ |
| Kinematic Viscosity | 2.0 | 3.5 | 3.4 | 6.8 | 6.7 |
| @ 100° C., cSt | (1.8-2.2) | (3.2-4.0) | (3.2-3.6) | (5.0-10.0) | (5.0-9.0) |

Generally, the oxidized olefin wax can be produced by a method comprising contacting an olefin wax with an oxidizing material to produce an oxidized olefin wax. In an embodiment, an oxidized olefin wax can be produced by a method comprising contacting an olefin wax with an oxygen-containing gas to produce an oxidized wax.

In an embodiment, the method can comprise contacting an olefin wax with an oxidizing agent to produce an oxidized olefin wax under conditions capable of forming an oxidized olefin wax. Conditions capable of forming the oxidized olefin can include a temperature at which the oxidized olefin wax can be formed and/or a time over which the oxidized olefin wax can be formed, among other conditions described herein.

In another embodiment, the method can comprise contacting an olefin wax with an oxidizing agent to produce an oxidized olefin wax having particular properties (e.g., acid number saponification number, 100° C. kinematic viscosity, needle penetration, and/or drop melt point, among others described herein). The properties of the oxidized olefin wax are independently described herein and can be utilized in any combination (and in any combination with the conditions and parameters of the method) to describe the method to produce the oxidized olefin wax.

The method by which the oxidized olefin wax can be produced can include additional parameters (e.g., the oxygen content of the oxygen-containing gas, the presence of absence of a catalyst, and/or whether or not the feedstock olefin wax composition is mixed, stirred, or agitated during contact with the oxygen-containing gas, among other parameters) described herein and/or steps described herein. These additional parameters and steps are independently described herein and can be utilized in any combination to describe the method by which the oxidized olefin wax can be produced.

Generally, the method by which the olefin wax can be produced can be described using any combination of the independently described forming conditions, oxidized olefin wax properties, and/or method steps described herein.

In an aspect, the olefin wax and oxidizing agent can be contacted with an oxidation catalyst; or alternatively, the oxidized olefin wax can be formed in the presence of a catalyst. In some embodiments, the contacting step can include contacting the olefin wax and oxidizing agent with an oxidation catalyst; or alternatively, the oxidized olefin wax can be formed in the absence of a catalyst. In a catalytic embodiment, the oxidation catalyst can comprise, or consist essentially of a metal compound. In some embodiments, the metal of the oxidation catalyst can comprise or consist essentially of manganese or cobalt; alternatively, manganese; or alternatively, cobalt.

In an embodiment, the oxidizing agent can comprise an oxygen-containing gas. Generally, the oxygen-containing gas can be any gas containing oxygen. In some embodiments, the oxygen-containing gas can be pure oxygen, oxygen diluted with an inert gas, air, or air diluted with an inert gas, among others; alternatively, pure oxygen; alternatively, oxygen diluted with an inert gas; alternatively, air; or alternatively, air diluted with an inert gas. Inert gases which can be utilized to dilute oxygen or air can include helium, nitrogen, argon, or any combination thereof; alternatively, helium; alternatively, nitrogen; or alternatively, argon. In some non-limiting embodiments, mixtures of oxygen diluted with an inert gas or gases can include, but are not limited to, mixtures of oxygen and nitrogen, mixtures of oxygen and argon, mixtures of oxygen and a noble gas(es), or mixtures of oxygen, nitrogen, and argon; alternatively, mixtures of oxygen and nitrogen; alternatively, mixtures of oxygen and argon; alternatively, mixtures of oxygen and a noble gas(es); or alternatively, mixtures of oxygen, nitrogen, and argon. In one embodiment, all gases other than oxygen in the mixture can be nitrogen and/or a noble gas(es). In an embodiment, the oxygen-containing gas can be pure oxygen. In some cases, the oxygen-containing gas is oxygen diluted with an inert gas. In an embodiment, the oxygen-containing gas can comprise less than 50 weight percent oxygen (e.g., via dilution of pure oxygen with an inert gas); or alternatively, less than 20 weight percent oxygen (e.g., via dilution of pure oxygen or air with an inert gas or dilution of air with an inert gas). In some cases, the oxygen-containing gas can be oxygen-enriched air which herein refers to air having an oxygen content of greater than 23 weight percent oxygen. In some cases, the oxygen-containing gas can be air. In a further embodiment, the oxygen-containing gas can comprise less than 22 weight percent oxygen. In some cases, the oxygen-containing gas can be air diluted with an inert gas (e.g., nitrogen or any noble gas described herein).

In an embodiment, the olefin wax and oxidizing agent can be contacted in any suitable vessel and/or reactor under any set of conditions suitable for contacting the olefin wax and oxidizing agent. In some embodiments, the contacting of the olefin wax and oxidizing agent can occur in a vessel and the components agitated using any suitable means for agitation (e.g., stirrer, mixer). In an alternative embodiment, the olefin wax and oxidizing agent can be contacted in the absence of agitation. In an embodiment, an oxygen-containing gas can be bubbled through a liquid olefin wax (with or without mixing, stirring, or other agitation of the melted wax).

In an embodiment, the conditions under which the oxidized olefin can be formed can comprise a temperature greater than the melting point of the olefin wax (also referred to as the olefin wax melting point). In an embodiment, the conditions under which the oxidized olefin can be formed can comprise a temperature ranging from the olefin wax melting point to 300° C. In a further embodiment, the conditions under which the oxidized olefin can be formed can comprise a temperature ranging from 80° C. to 300° C.; alternatively, from 80° C. to 200° C.; alternatively, from 90° C. to 180° C.; alternatively, from 100° C. to 160° C.; or alternatively, from 110° C. to 150° C.

In an embodiment wherein air can be utilized as the oxygen-containing gas, the conditions under which the oxidized olefin can be formed can comprise contacting air with the olefin wax at an air flow rate of at least 0.1 cubic foot per hour per kilogram (ft³/hr/kg) olefin wax. In a further embodiment wherein air can be utilized as the oxygen-containing gas, the conditions under which the oxidized olefin can be formed can comprise an air flow rate ranging from 0.1 ft³/hr/kg olefin wax to 30 ft³/hr/kg olefin wax; alternatively, from 0.5 ft³/hr/kg olefin wax to 20 ft³/hr/kg olefin wax; alternatively, from 1.0 ft³/hr/kg olefin wax to 15 ft³/hr/kg olefin wax; alternatively, from 1.5 ft³/hr/kg olefin wax to 12 ft³/hr/kg olefin wax; or alternatively, from 2 ft³/hr/kg olefin wax to 10 ft³/hr/kg olefin wax.

Generally, the oxidized olefin wax can be formed under conditions comprising any oxidation duration necessary to form the desired oxidized olefin wax properties. In an embodiment, the oxidized olefin wax can be formed under conditions comprising an oxidation duration from 1 minute to 48 hours. In a further embodiment, the oxidized olefin wax can be formed under conditions comprising an oxidation duration from 2 hours to 30 hours. In a further embodiment, the oxidized olefin wax can be formed under conditions comprising an oxidation duration from 4 hours to 24 hours.

In an embodiment wherein air is utilized as the oxygen-containing gas, the oxidized olefin wax can be formed under conditions comprising a low air flow. In this low air flow embodiment, the oxidized olefin wax can be formed under conditions comprising an air flow rate less than 0.1 ft³/hr/kg olefin wax. In another low air flow embodiment, the oxidized olefin wax can be formed under conditions comprising a substantial absence of olefin wax agitation. In another low air flow embodiment, oxidized olefin wax can be formed under conditions comprising any oxidation duration necessary to provide the desired oxidized olefin wax properties under the oxidation conditions employed (e.g., contact temperature). In yet another low air flow embodiment, the oxidized olefin wax can be formed under conditions comprising an oxidation duration of at least 24 hours.

The oxidation of the feedstock olefin wax can yield an oxidized olefin wax that can comprise volatile compounds. In an embodiment, the method to produce an oxidized olefin wax can further comprise one or more steps directed to removing or reducing the quantity of volatile compounds from the oxidized olefin wax. Generally, the method or the one or more steps utilized to remove or reduce the quantity of volatile compounds from the oxidized olefin wax can comprise any method or any steps known the art for removing or reducing volatile compounds. In some embodiments, the process for producing an oxidized olefin wax can include removing or reducing the quantity of volatile compounds comprising one or more steps comprising subjecting the oxidized olefin wax to vacuum, subjecting the oxidized olefin wax to heat, subjecting the oxidized olefin wax to inert gas sparging (e.g., nitrogen sparging), contacting the oxidized olefin wax with activated charcoal, clay and/or alumina, or any combination thereof; alternatively, subjecting the oxidized olefin wax to vacuum, subjecting the oxidized olefin wax to heat, subjecting the oxidized olefin wax to inert gas sparging (e.g., nitrogen sparging), or any combination thereof; or alternatively, contacting the oxidized olefin wax with activated charcoal, clay, and/or alumina.

In an embodiment, a step of removing or reducing the quantity of volatile compounds in an oxidized olefin wax can comprise, or consist essentially of, applying a vacuum to a vessel containing the oxidized olefin wax. In some embodiments, the step of removing or reducing the quantity of volatile compounds in an oxidized olefin wax can comprise, or consist essentially of, applying heat to a vessel containing the oxidized olefin wax. In other embodiments, the step of removing or reducing the quantity of volatile compounds in an oxidized olefin wax can comprise, or consist essentially of, sparging (i.e., bubbling) an inert gas though the oxidized olefin wax. In some other embodiments, the step of removing or reducing the quantity of volatile compounds in an oxidized olefin wax can comprise, or consist essentially of, applying heat and vacuum to a vessel containing the oxidized olefin wax. In yet other embodiments, the step of removing or reducing the quantity of volatile compounds in an oxidized olefin wax can comprise, or consist essentially of, sparging the oxidized olefin wax in a vessel under vacuum. In further embodiments, the step of removing or reducing the quantity of volatile compounds in an oxidized olefin wax can comprise, or consist essentially of, sparging an inert gas though the oxidized olefin wax in a vessel under vacuum. In yet further embodiments, the step of removing or reducing the quantity of volatile compounds in an oxidized olefin wax can comprise, or consist essentially of, sparging an inert gas though the heated oxidized olefin wax. In still another embodiment, the oxidized olefin wax composition can be mixed, stirred, or agitated during the step(s) for reducing the quantity of volatile compounds in an oxidized olefin wax. In an embodiment, the step of removing or reducing the quantity of volatile compounds in an oxidized olefin wax can comprise, or consist essentially of, passing the oxidized olefin wax through a wiped film evaporator.

The step of heating, sparging, applying vacuum, or any combination thereof to the oxidized olefin wax to remove or reduce the quantity of volatile compounds in the oxidized olefin wax can occur for a duration of 1 hour to 72 hours; alternatively, from 1 hour to 48 hours; alternatively, from 1 hour to 24 hours, or alternatively, from 1 hour to 12 hours. The heating of the oxidized olefin wax to remove or reduce the quantity of volatile compounds in the oxidized olefin wax can occur at any temperature which can drive off the volatile compounds under the condition employed (e.g., under vacuum, with or without sparging, and/or within a particular time). In some embodiments, the temperature at which the quantity of volatile compounds in the oxidized olefin wax can be removed or reduced can range from the melting point of the oxidized olefin wax composition to 250° C.; alternatively, from the melting point of the oxidized olefin wax composition to 200° C.; alternatively, from 60° C. to 200° C.; or alternatively, from 80° C. to 200° C.

In an aspect, the oxidized olefin wax can have desirable properties such as drop melt point, needle penetration, kinematic viscosity, acid number, saponification number, or any combination thereof. In some embodiments, the desirable properties can be described in relation to the same property of the olefin wax from which the oxidized olefin wax was produced. These oxidized olefin wax properties are independently described herein and can be utilized in any combination to describe the oxidized olefin wax.

In general, the absolute value of the needle penetration of the oxidized olefin wax can be influenced by the needle penetration of the olefin wax from which it can be produced. In turn, the needle penetration of the olefin wax can vary widely depending upon the compositional makeup of the olefin wax. Consequently, the needle penetration of the oxidized olefin wax can be described in relation to the needle penetration of the olefin wax from which it can be produced. In an embodiment, the oxidized olefin wax can have a 25° C. needle penetration value less than the 25° C. needle penetration value of the olefin wax from which it was produced. In some embodiments, the oxidized olefin wax can have a needle penetration value at least 5% less than the needle penetration value of the olefin wax; alternatively, at least 10% less than the needle penetration value of the olefin wax; alternatively, at least 20% less than the needle penetration value of the olefin wax; alternatively, at least 30% less than the needle penetration value of the olefin wax; alternatively, at least 40% less than the needle penetration value of the olefin wax; or alternatively, at least 50% less than the needle penetration value of the olefin wax. In another embodiment, the oxidized olefin wax can have a needle penetration value between 400 percent greater than and 75 percent less than the needle penetration value of the olefin wax; alternatively, from 0 percent greater to 400 percent greater than the needle penetration of the olefin wax; alternatively, from 0 percent greater to 300 percent greater than the needle penetration of the olefin wax; alternatively, from 0 percent greater to 200 percent greater than the needle penetration of the olefin wax; or alternatively, from 0 percent greater to 100 percent greater than the needle penetration of the olefin wax composition.

In general, the absolute value of the drop melt point of the oxidized olefin wax is influenced by the drop melt point of the olefin wax from which it is produced. In turn, the drop melt point of the olefin wax can vary widely depending upon the compositional makeup of the olefin wax. Consequently, the drop melt point of the oxidized olefin wax can be appropriately described in relation to the drop melt point of the olefin wax from which it is produced. In an embodiment, the oxidized olefin wax can have a drop melt point within ±20 percent of the drop melt point of the olefin wax from which it was produced; alternatively, within ±15 percent of the drop melt point of the olefin wax from which it was produced; alternatively, within ±10 percent of the drop melt point of the olefin wax from which it was produced; or alternatively, within ±5 percent of the drop melt point of the olefin wax from which it was produced.

In an embodiment, the 100° C. kinematic viscosity of the oxidized olefin wax can be less than 70 cSt. In another embodiment, the 100° C. kinematic viscosity of the oxidized olefin wax can range from 2 cSt to 80 cSt; alternatively, range from 2 cSt to 70 cSt; alternatively, range from 2.5 cSt to 60 cSt; alternatively, range from 3 cSt to 50 cSt; or alternatively, range from 5 cSt to 25 cSt. In other embodiments, the 100° C. kinematic viscosity of the oxidized olefin wax can be described in relation to the 100° C. kinematic viscosity of the olefin wax from which it is produced. In an embodiment, the 100° C. kinematic viscosity of the oxidized olefin wax can have a 100° C. kinematic viscosity up to 10 times the 100° C. kinematic viscosity of the olefin wax from which it is produced; alternatively, up to 8 times the 100° C. kinematic viscosity of the olefin wax from which it is produced; alternatively, up to 6 times the 100° C. kinematic viscosity of the olefin wax from which it is produced; alternatively, up to 5 times the 100° C. kinematic viscosity of the olefin wax from which it is produced; or alternatively, up to 4 times the 100° C. kinematic viscosity of the olefin wax from which it is produced.

In an embodiment, the oxidized olefin wax can have a saponification number greater than 5 mg KOH per g oxidized olefin wax. In another embodiment, the oxidized olefin wax can have a saponification value ranging from 5 mg KOH per g oxidized olefin wax to 500 mg KOH per g oxidized olefin wax; alternatively, ranging from 7 mg KOH per g oxidized olefin wax to 400 mg KOH per g oxidized olefin wax; alternatively, ranging from 9 mg KOH per g oxidized olefin wax to 300 mg KOH per g oxidized olefin wax; alternatively, ranging from 10 mg KOH per g oxidized olefin wax to 200 mg KOH per g oxidized olefin wax.

In an embodiment, the oxidized olefin wax can have an acid number greater than 1 mg KOH per g oxidized olefin wax. In another embodiment, the oxidized olefin wax can have an acid value ranging from 1 mg KOH per g oxidized olefin wax to 200 mg KOH per g oxidized olefin wax; alternatively, ranging from 2 mg KOH per g oxidized olefin wax to 100 mg KOH per g oxidized olefin wax; alternatively, ranging from 3 mg KOH per g oxidized olefin wax to 75 mg KOH per g oxidized olefin wax; alternatively, ranging from 4 mg KOH per g oxidized olefin wax to 50 mg KOH per g oxidized olefin wax.

Generally, the independently described properties of the oxidized olefin wax can be combined in any manner to describe the oxidized olefin wax. In a non-limiting embodiment, the oxidized olefin wax can have an acid number greater than 1 mg KOH per g oxidized olefin wax and a kinematic viscosity less than about 70 cSt at 100° C. In a non-limiting embodiment, the oxidized olefin wax can have a needle penetration value at 25° C. at least 5 percent less than the needle penetration value at 25° C. of the olefin wax and a kinematic viscosity at 100° C. of up to about 500% greater than the kinematic viscosity of the olefin wax. Other embodiments describing the oxidized olefin wax by its properties are readily apparent from aspects and embodiments described in the present disclosure.

Additionally, the method by which the oxidized olefin wax can be produced can be described utilizing one or more properties of the produced oxidized olefin wax. The properties of the oxidized olefin wax combination can be utilized in combination with any features of the method to produce the oxidized olefin wax. In a non-limiting example, the oxidized olefin wax can be produced utilizing a method comprising contacting an olefin wax with a oxidizing agent to form an oxidized olefin wax having an acid number greater than 1 mg KOH per g oxidized olefin wax; alternatively, to form an oxidized olefin wax having a saponification number greater than 1 mg KOH per g oxidized olefin wax composition; alternatively, to form an oxidized olefin wax having a needle penetration greater than the needle penetration of the olefin wax and acid number greater than 1 mg KOH per g oxidized olefin wax; alternatively, to form an oxidized olefin wax that can have an acid number greater than 1 mg KOH per g oxidized olefin wax; or alternatively, to form an oxidized olefin wax having a needle penetration greater than the needle penetration of the olefin wax and having a 100° C. kinematic viscosity of the oxidized olefin wax composition less than 70 cSt. In another non-limiting embodiment, the oxidized olefin wax can be produced by a method comprising contacting an olefin wax with an oxidizing material to produce an oxidized olefin wax under conditions capable of forming an oxidized wax comprising a temperature greater than the melting point of the feedstock olefin wax composition, wherein the oxidized olefin wax can have an acid number greater than 1 mg KOH per g oxidized olefin wax; alternatively, a saponification number greater than 1 mg KOH per g oxidized olefin wax; alternatively, a needle penetration greater than the needle penetration of the olefin wax and an acid number greater than 1 mg KOH per g oxidized olefin wax; alternatively, an acid number greater than 1 mg KOH per g oxidized olefin wax; or alternatively, a needle penetration greater than the needle penetration of the olefin wax and a 100° C. kinematic viscosity of the oxidized olefin wax can be less than 70 cSt. Other aspects and embodiments of the method are readily apparent from aspects and embodiments described in the present disclosure.

In an aspect, an odor-reduced oxidized olefin wax can be produced by any method comprising contacting the oxidized olefin wax with an odor-reducing material to produce an odor-reduced oxidized olefin wax. In an embodiment, the odor-reduced oxidized olefin wax can be produced by a method comprising contacting the oxidized olefin wax with an odor-reducing material to produce an odor-reduced oxidized olefin wax under conditions capable of forming an odor-reduced oxidized olefin wax. Generally, the oxidized olefin wax, the odor-reducing material, the conditions and/or method by which the oxidized olefin wax and the oxidizing agent can be contacted, the conditions under which the odor-reduced oxidized olefin wax can be produced, other method steps which can be utilized in the method, properties of the odor-reduced oxidized olefin wax, and/or the compositional make-up of the odor-reduced oxidized olefin wax are independent features of the method. These independent features are independently described herein and can be utilized in any combination to describe the method of producing the odor-reduced oxidized olefin wax.

In some embodiments, the method for producing the odor-reduced oxidized olefin wax can further comprise steps for producing the oxidized olefin wax. The method by which the oxidized olefin wax can be produced is independently described herein and the features of the method by which the oxidized olefin wax can be produced can be utilized in any manner to further describe the method to produce an odor-reduced oxidized olefin wax. In a non-limiting embodiment, the method of producing the odor-reduced oxidized olefin wax can comprise i) contacting an olefin wax with an oxidizing agent to produce an oxidized olefin wax under conditions capable of forming an oxidized olefin wax; and ii) contacting the oxidized olefin wax with an odor-reducing material to produce an odor-reduced olefin wax under conditions capable of forming an odor-reduced oxidized olefin wax.

In an embodiment, any oxidized olefin wax described herein (or produced by any process described herein) can be contacted with one or more odor-reducing materials. In some embodiments, the odor-reducing material can comprise, or consist essentially of, a metal hydroxide, a metal carbonate, a metal bicarbonate, a metal carboxylate, or any combination thereof; alternatively, a metal hydroxide, a metal carbonate, a metal bicarbonate, or any combination thereof; alternatively, a metal carbonate, a metal bicarbonate, or any combination thereof; alternatively, a metal hydroxide; alternatively, a metal carbonate; alternatively, a metal bicarbonate; or alternatively, a metal carboxylate. In an embodiment, the metal of any metal hydroxide, metal carbonate, and/or metal carboxylate can be a Group 1 metal, a Group 2 metal, or any combination thereof; alternatively, a Group 1 metal; or alternatively, a Group 2 metal.

In an aspect, the Group 1 metal of the odor-reducing material can be, comprise, or consist essentially of, lithium, sodium, potassium, rubidium, cesium, or any combination thereof. In an embodiment, the Group 1 metal of the odor-reducing material can be, comprise, or consist essentially of, lithium; alternatively, sodium; alternatively, potassium; alternatively, rubidium; or alternatively, cesium. In an aspect, the Group 2 metal of the odor-reducing material can be, comprise, or consist essentially of, beryllium, magnesium, calcium, strontium, or barium, or any combination thereof. In an embodiment, the Group 2 metal of the odor-reducing material can be, comprise, or consist essentially of, beryllium; alternatively, magnesium; alternatively, calcium; alternatively, strontium; or alternatively, barium.

In an aspect, the carboxylate of any metal carboxylate which can be used as the odor-reducing material can be a carboxylate of an aliphatic carboxylic acid, an aromatic carboxylic acid, or any combination thereof; alternatively, an aliphatic carboxylic acid; or alternatively, an aromatic carboxylic acid. In some embodiments, the aliphatic carboxylic acid can be a saturated carboxylic acid, an unsaturated carboxylic acid, or any combination thereof; alternatively, a saturated carboxylic acid; or alternatively, an unsaturated carboxylic acid. In other embodiments, the carboxylate (aliphatic or aromatic) of any metal carboxylate which can be used as the odor-reducing material can be a C₆ to C₄₀ carboxylate; alternatively, a C₈ to C₃₀ carboxylate; alternatively, a C₁₀ to C₂₆ carboxylate; or alternatively, a C₁₂ to C₂₄ carboxylate. In an embodiment, the carboxylate (aliphatic or aromatic) of any metal carboxylate which can be used as the odor-reducing material can be a carboxylate of an carboxylic acid having a melting point of at least 50° C.; alternatively, 60° C.; alternatively, 70° C. In some embodiments, any metal carboxylate which can be used as the odor-reducing material can be a carboxylate of a hexanoic acid, a heptanoic acid, an octanoic acid, a nonanoic acid, a decanoic acid, an undecanoic acid, a dodecanoic acid, a tridecanoic acid, a tetradecanoic acid, a pentadecanoic acid, a hexadecanoic acid, a heptadecanoic acid, an octadecanoic acid, or any combination thereof. Generally, the type of carboxylic acid, carbon number of the carboxylic acid, and melting point of the carboxylic acid are independent elements of the carboxylic acid. In an embodiment, the carboxylate of any metal carboxylate which can be used as the odor-reducing material can be a stearic acid (i.e., a metal stearate). The carboxylate of any metal carboxylate which can be used as the odor-reducing material can be a carboxylic acid having any combination of these independent elements.

In a non-limiting embodiment, the odor-reducing material can comprise, or consist essentially of, calcium hydroxide, calcium carbonate, calcium bicarbonate, a calcium carboxylate, or any combination thereof. In another non-limiting embodiment, the odor-reducing material can comprise, or consist essentially of, calcium hydroxide, calcium carbonate, calcium bicarbonate, or any combination thereof; alternatively, calcium carbonate, calcium bicarbonate, or any combination thereof; alternatively, calcium hydroxide, calcium carbonate; alternatively, calcium bicarbonate; or alternatively, a calcium carboxylate. In some embodiments, the odor-reducing material can comprise, or consist essentially of calcium stearate. Other embodiments of odor-reducing material embodiments are readily apparent from aspects and embodiments described in the present disclosure.

In an embodiment, the amount of odor-reducing material (e.g., calcium hydroxide) contacted with the oxidized olefin wax can range from 5 to 1500 milliequivalents of odor-reducing material per acid number KOH equivalents per gram of oxidized olefin wax; alternatively, from 10 to 1250 milliequivalents of odor-reducing material per acid number KOH equivalents per gram of oxidized olefin wax; or alternatively, from 50 to 1000 milliequivalents of odor-reducing material per acid number KOH equivalents per gram of oxidized olefin wax.

Generally, the odor-reducing material can be in any form which can be easily dispersed within a liquefied (melted) oxidized olefin wax. In some embodiments, the odor-reducing material can be in the form of a solid. In some embodiments, the odor-reducing material can be in the form of a powder or flakes; alternatively, powder; or alternatively, flakes. In some embodiments, the odor-reducing material can be in the form of a concentrated aqueous solution; or alternatively, a concentrated organic solution.

In an embodiment, the oxidized olefin wax and odor-reducing material can contacted in any suitable vessel and/or under any set of conditions suitable for contacting the oxidized olefin wax and reducing material. In some embodiments, the contacting of the oxidized olefin wax and odor-reducing material can occur in a vessel and the components agitated using any suitable means for agitation (e.g., stirrer, mixer). In an alternative embodiment, the oxidized olefin wax and odor-reducing material are contacted in the absence of agitation. In another embodiment, the oxidized olefin wax and odor-reducing material can be contacted in the substantial absence of added water (alternatively, the conditions under which the odor-reduced oxidized olefin can be formed can comprise the substantial absence of added water).

In an embodiment, the conditions under which the odor-reduced oxidized olefin can be formed can comprise a temperature above the melting point of the oxidized olefin (also referred to as the oxidized olefin wax melting point). In some embodiments, the conditions under which the odor-reduced oxidized olefin can be formed can comprise a temperature ranging from the oxidized olefin wax melting point to 300° C. In a further embodiment, the oxidation of the feedstock olefin wax can occur at a temperature ranging from 100° C. to 250° C.; alternatively, from 110° C. to 225° C.; or alternatively, from 120° C. to 200° C.

Generally, the odor-reduced oxidized olefin wax can be formed under conditions comprising any duration necessary to form the odor-reduced oxidized olefin wax. In some embodiments, the odor-reduced oxidized olefin wax can be formed under conditions comprising any duration necessary to form the odor-reduced oxidized olefin wax under the conditions employed (e.g., contact temperature, and or whether or not any form of agitation is utilized). In an embodiment, the odor-reduced oxidized olefin wax can be formed under conditions comprising a duration ranging from 10 minute to 24 hours; alternatively, from 15 minutes to 12 hours. In a further embodiment, the odor-reduced oxidized olefin wax can be formed under conditions comprising a duration from 20 minutes to 6 hours.

In an embodiment, the formation of the odor-reduced oxidized olefin wax can produce water. When the formation of the odor-reduced oxidized olefin wax produces water, the method to produce the odor-reduced oxidized olefin wax can include a step (or steps) to remove at least a portion or all of the water from the odor-reduced oxidized olefin wax. Alternatively (or additionally), when the formation of the odor-reduced oxidized olefin wax produces water, the method to produce the odor-reduced oxidized olefin wax can include a step (or steps) to remove at least a portion of the water from the odor-reduced oxidized olefin wax.

In an aspect, the step (or steps) for removing water from the odor-reduced oxidized olefin wax can comprise one or more steps comprising subjecting the odor-reduced oxidized olefin wax to vacuum, subjecting the odor-reduced oxidized olefin wax to heat, subjecting the odor-reduced oxidized olefin wax to inert gas sparging (e.g., nitrogen sparging), or any combination thereof. In an embodiment, the step of removing water from the odor-reduced oxidized olefin wax can comprise, or consist essentially of, applying a vacuum to a vessel containing the odor-reduced oxidized olefin wax. In some embodiments, the step of removing water from the odor-reduced oxidized olefin wax can comprise, or consist essentially of applying heat to a vessel containing the odor-reduced oxidized olefin wax. In other embodiments, the step of removing water from the odor-reduced oxidized olefin wax can comprise, or consist essentially of, sparging (i.e., bubbling) an inert gas though the odor-reduced oxidized olefin wax. In some other embodiments, the step of removing water from the odor-reduced oxidized olefin wax can comprise, or consist essentially of applying heat and vacuum to a vessel containing the odor-reduced oxidized olefin wax. In yet other embodiments, the step of removing water from the odor-reduced oxidized olefin wax can comprise, or consist essentially of, sparging the odor-reduced oxidized olefin wax in a vessel under vacuum. In further embodiments, the step of removing water from the odor-reduced oxidized olefin wax can comprise, or consist essentially of, sparging an inert gas though the odor-reduced oxidized olefin wax in a vessel under vacuum. In yet further embodiments, the step of removing water from the odor-reduced oxidized olefin wax can comprise, or consist essentially of sparging an inert gas though a heated odor-reduced oxidized olefin wax. In still another embodiment, the oxidized olefin wax composition can be mixed, stirred, or agitated during the step(s) of removing water from the odor-reduced oxidized olefin wax. In an embodiment, the step of removing water from the odor-reduced oxidized olefin wax can comprise, or consist essentially of passing the odor-reduced oxidized olefin wax through a wiped film evaporator.

The step of heating, sparging, applying vacuum, or any combination thereof to the odor-reduced oxidized olefin wax to remove or reduce the quantity of water in the odor-reduced oxidized olefin wax can occur for a duration of 10 hours to 24 hours; alternatively, from 15 minutes to 12 hours; or alternatively, from 20 minutes to 6 hours. The heating of the odor-reduced oxidized olefin wax to remove or reduce the quantity of water in the odor-reduced oxidized olefin wax can occur at any temperature which can drive off the water under the conditions employed (e.g., under vacuum, with or without sparging, and/or within a particular time). In some embodiments, the temperature at which a quantity of water in the odor-reduced oxidized olefin wax can be removed or reduced can range from the melting point of the odor-reduced oxidized olefin wax composition to 250° C.; alternatively, from 80° C. to 200° C.; or alternatively, from 100° C. to 200° C.

In an aspect, it may not be necessary to cool, isolate, and/or devolatilize the oxidized olefin wax before contacting it with the odor-reducing material. In an aspect, it may not be necessary to cool, isolate, and/or devolatilize the oxidized olefin wax before initiating any step to remove water from the odor-reduced oxidized olefin wax.

In an aspect, the present disclosure describes compositions comprising a) an oxidized olefin wax and an odor-reducing material, b) an oxidized olefin wax and a reaction product of a component of the oxidized olefin wax and an odor-reducing material, or c) an oxidized olefin wax, an odor-reducing material, and a reaction product of a component of the oxidized olefin wax and an odor-reducing material. In an embodiment, the composition (which also can be referred to as an odor-reduced oxidized olefin wax, or an odor-reduced oxidized olefin wax composition) can have desirable properties such as no or minimal odor, drop melt point, needle penetration, and/or kinematic viscosity. In some embodiments, these desirable properties can be described in relation to the same property of the oxidized olefin wax from which the odor-reduced oxidized olefin wax was prepared. These odor-reduced oxidized olefin wax properties are independently described herein and can be utilized in any combination to describe the odor-reduced oxidized olefin wax composition.

In an embodiment, the odor-reduced oxidized olefin wax can have a reduced odor when compared to an otherwise similar composition lacking an odor-reducing material.

In an embodiment, the absolute value of the needle penetration of the odor-reduced oxidized olefin wax can be influenced by the needle penetration of the oxidized olefin wax from which it is produced. In turn, the needle penetration of the oxidized olefin wax can vary widely depending upon its compositional makeup, the olefin wax from which it can be prepared, and the conditions by which the oxidized olefin wax can be prepared. Consequently, the needle penetration of the odor-reduced oxidized olefin wax can be appropriately described in relation to the needle penetration of the oxidized olefin wax from which it can be produced. In an embodiment, the odor-reduced oxidized olefin wax can have a 25° C. needle penetration value less than the 25° C. needle penetration value of the oxidized olefin wax. In some embodiments, the odor-reduced oxidized olefin wax can have a needle penetration value at least 5% less than the needle penetration value of the oxidized olefin wax; alternatively, at least 10% less than the needle penetration value of the oxidized olefin wax; alternatively, at least 20% less than the needle penetration value of the oxidized olefin wax; alternatively, at least 30% less than the needle penetration value of the oxidized olefin wax; alternatively, at least 40% less than the needle penetration value of the oxidized olefin wax; or alternatively, at least 50% less than the needle penetration value of the oxidized olefin wax.

In general, the absolute value of the drop melt point of the odor-reduced oxidized olefin wax can be influenced by the drop melt point of the oxidized olefin wax from which it can be produced. In turn, the drop melt point of the oxidized olefin wax can vary widely depending upon its compositional makeup, the olefin wax from which it can be prepared, and the conditions by which olefin wax can be prepared. Consequently, the drop melt point of the odor-reduced oxidized olefin wax can be appropriately described in relation to the drop melt point of the oxidized olefin wax from which it is produced. In an embodiment, the odor-reduced oxidized olefin wax can have a drop melt point within ±20 percent of the drop melt point of the oxidized olefin wax from which it was produced; alternatively, within ±15 percent of the drop melt point of the oxidized olefin wax from which it was produced; alternatively, within ±10 percent of the drop melt point of the oxidized olefin wax from which it was produced; or alternatively, within ±5 percent of the drop melt point of the oxidized olefin wax from which it was produced.

In an embodiment, the 100° C. kinematic viscosity of the odor-reduced oxidized olefin wax composition can be less than 200 cSt. In another embodiment, the 100° C. kinematic viscosity of the odor-reduced oxidized olefin wax composition can range from 5 cSt to 200 cSt; alternatively, range from 7 cSt to 150 cSt; alternatively, range from 8 cSt to 140 cSt; alternatively, range from 9 cSt to 130 cSt; or alternatively, range from 10 cSt to 120 cSt. In other embodiments, the 100° C. kinematic viscosity of the odor-reduced oxidized olefin wax can be described in relation to the 100° C. kinematic viscosity of the oxidized olefin wax from which it is produced. In an embodiment, the 100° C. kinematic viscosity of the odor-reduced oxidized olefin wax composition can have a 100° C. kinematic viscosity up to 6 times the 100° C. kinematic viscosity of the oxidized olefin wax from which it is produced; alternatively, up to 5 times the 100° C. kinematic viscosity of the oxidized olefin wax from which it is produced; alternatively, up to 4.5 times the 100° C. kinematic viscosity of the oxidized olefin wax from which it is produced; alternatively, up to 4 times the 100° C. kinematic viscosity of the oxidized olefin wax from which it is produced; or alternatively, up to 3.5 times the 100° C. kinematic viscosity of the oxidized olefin wax from which it is produced.

In an embodiment, an odor-reduced oxidized olefin wax described herein can find utility in applications, such as polishing, coating, printing, and various construction material formulations. In an embodiment, an odor-reduced olefin wax described herein can be used as a substitute for high cost natural waxes, such as Montan waxes, carnuba waxes, and other types of vegetable waxes and animal waxes.

For the purpose of any U.S. national stage filing from this application, all publications and patents mentioned in this disclosure are incorporated herein by reference in their entireties, for the purpose of describing and disclosing the constructs and methodologies described in those publications, which might be used in connection with the methods of this disclosure. Any publications and patents discussed above and throughout the text are provided solely for their disclosure prior to the filing date of the present application. Nothing herein is to be construed as an admission that the inventors are not entitled to antedate such disclosure by virtue of prior invention.

Unless indicated otherwise, where numerical ranges or limitations are expressly stated, such ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R_{L}, and an upper limit, R₁₅, is disclosed, any number falling within the range is specifically disclosed. In particular, the following numbers within the range are specifically disclosed: R═R_{L}+k*(R_{U}−R_{L}), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim is intended to mean that the subject element is required, or alternatively, is not required. Both alternatives are intended to be within the scope of the claim. Use of broader terms such as can comprise, includes, having, etc. should be understood to provide support for narrower terms such as consisting of, consisting essentially of, comprised substantially of, etc.

For any particular compound disclosed herein, the general name and/or structure presented is also intended to encompass all conformational isomers and stereoisomers that can arise from a particular set of substituents, unless indicated otherwise. Thus, the general name and/or structure encompasses all structural isomer (e.g., a reference to a propyl group includes n-propyl and iso-propyl, or e.g., a reference to pentane includes n-pentane, 2-methylpentane, and 2,2-dimethylpentane), enantiomers, diastereomers, and other optical isomers whether in enantiomeric or racemic forms, as well as mixtures of stereoisomers, as the context permits or requires, unless specifically indicated otherwise. For any particular formula that is presented, any general formula presented also encompasses all conformational isomers, regioisomers, and stereoisomers that can arise from a particular set of substituents. Moreover and unless otherwise specified, the disclosure of a general compound or structure that can encompass more than one regioisomer is intended to encompass all possible regioisomers within such a general disclosure.

In any application before the United States Patent and Trademark Office, the Abstract of this application is provided for the purpose of satisfying the requirements of 37 C.F.R. §1.72 and the purpose stated in 37 C.F.R. §1.72(b) “to enable the United States Patent and Trademark Office and the public generally to determine quickly from a cursory inspection the nature and gist of the technical disclosure.” Therefore, the Abstract of this application is not intended to be used to construe the scope of the claims or to limit the scope of the subject matter that is disclosed herein. Moreover, any headings that can be employed herein are also not intended to be used to construe the scope of the claims or to limit the scope of the subject matter that is disclosed herein. Any use of the past tense to describe an example otherwise indicated as constructive or prophetic is not intended to reflect that the constructive or prophetic example has actually been carried out.

The present disclosure is further illustrated by the following examples, which are not to be construed in any way as imposing limitations upon the scope thereof. On the contrary, it is to be clearly understood that recourse can be had to various other aspects, embodiments, modifications, and equivalents thereof which, after reading the description herein, can suggest themselves to one of ordinary skill in the art without departing from the spirit of the present invention or the scope of the appended claims.

The data and descriptions provided in the following examples are given to show particular aspects and embodiments of the compounds and methods disclosed, and to demonstrate a number of the practices and advantages thereof. The examples are given as a more detailed demonstration of some of the aspects and embodiments described herein and are not intended to limit the disclosure or claims in any manner.

### EXAMPLES

The invention having been generally described, the following examples are given as particular embodiments of the invention and to demonstrate the practice and advantages thereof. It is understood that the examples are given by way of illustration and are not intended to limit the specification of the claims to follow in any manner.

### Example 1

AlphaPlus® C30+ (Chevron Phillips Chemical Company LP), 500 g, was placed into a four-neck flask equipped with a heating mantle, a thermocouple, a single blade agitator, an air sparger (cylindrical, 1″ in length and ⅜″ in diameter, average pore size 15 μm), and a side arm connected to a receiving flask. The wax was heated to 130° C. and the agitation was set at 400 rpm. Then a steady stream of air was introduced at 1.7 cubic foot per hour (ft³/hr). The reaction was maintained at 130° C. for 24 hours. The contents were allowed to cool to 100° C. and were discharged. The resulting material appeared as a white to light yellow solid. The properties of the oxidized AlphaPlus® C30+ are provided in Table 2.

### Example 2

AlphaPlus® C30+HA (Chevron Phillips Chemical Company LP), 500 g, was placed into a four-neck flask, equipped with a heating mantle, a thermocouple, a single blade agitator, an air sparger (cylindrical, 1″ in length and ⅜″ in diameter, average pore size 15 μm), and a side arm connected to a receiving flask. The wax was heated to 130° C. and the agitation was set at 400 rpm. Then a steady stream of air was introduced at 1.7 ft³/hr. The reaction was maintained at 130° C. for 24 hours. The contents were allowed to cool to 100° C. and were discharged. The resulting material appeared as a white to light yellow solid. The properties of the oxidized AlphaPlus® C30+HA are provided in Table 2.

### Example 3

AlphaPlus® C30+ (Chevron Phillips Chemical Company LP), 500 g, was placed into a four-neck flask equipped with a heating mantle, a thermocouple, a single blade agitator, an air sparger (cylindrical, 1″ in length and ⅜″ in diameter, average pore size 15 μm), and a side arm connected to a receiving flask. The wax was heated to 145° C. and the agitation was set at 400 rpm. Then a steady stream of air was introduced at 3.4 ft³/hr. The reaction was maintained at 145° C. for 8 hours. The contents were allowed to cool to 100° C. and were discharged. The resulting material appeared as a white solid. The properties of the oxidized AlphaPlus® C30+ are provided in Table 2.

### Example 4

AlphaPlus® C30+HA (Chevron Phillips Chemical Company LP), 500 g, was placed into a four-neck flask equipped with a heating mantle, a thermocouple, a single blade agitator, an air sparger (cylindrical, 1″ in length and ⅜″ in diameter, average pore size 15 μm), and a side arm connected to a receiving flask. The wax was heated to 145° C. and the agitation was set at 400 rpm. Then a steady stream of air was introduced at 3.4 ft³/hr. The reaction was maintained at 145° C. for 8 hours. The contents were allowed to cool to 100° C. and were discharged. The resulting material appeared as a white solid. The properties of the oxidized AlphaPlus® C30+HA are provided in Table 2.

### Example 5

AlphaPlus® C26-28 (Chevron Phillips Chemical Company LP), 500 g, was placed into a four-neck flask equipped with a heating mantle, a thermocouple, a single blade agitator, an air sparger (cylindrical, 1″ in length and ⅜″ in diameter, average pore size 15 μm), and a side arm connected to a receiving flask. The wax was heated to 145° C. and the agitation was set at 400 rpm. Then a steady stream of air was introduced at 3.4 ft³/hr. The reaction was maintained at 145° C. for 8 hours. The contents were allowed to cool to 100° C. and were discharged. The resulting material appeared as a white solid. The properties of the oxidized AlphaPlus® C26-28 are provided in Table 2.

### Example 6

AlphaPlus® C30+ (Chevron Phillips Chemical Company LP), 500 g, was placed into a four-neck flask equipped with a heating mantle, a thermocouple, a single blade agitator, an air sparger (cylindrical, 1″ in length and ⅜″ in diameter, average pore size 15 μm), and a side arm connected to a receiving flask. The wax was heated to 145° C. and the agitation was set at 400 rpm. Then a steady stream of air was introduced at 3.4 ft³/hr. The reaction was maintained at 145° C. for 24 hours. The contents were allowed to cool to 100° C. and were discharged. The resulting material appeared as a yellow solid. The properties of the oxidized AlphaPlus® C30+ are provided in Table 2.

### Example 7

AlphaPlus® C30+HA (Chevron Phillips Chemical Company LP), 500 g, was placed into a four-neck flask equipped with a heating mantle, a thermocouple, a single blade agitator, an air sparger (cylindrical, 1″ in length and ⅜″ in diameter, average pore size 15 μm), and a side arm connected to a receiving flask. The wax was heated to 145° C. and the agitation was set at 400 rpm. Then a steady stream of air was introduced at 3.4 ft³/hr. The reaction was maintained at 145° C. for 24 hours. The contents were allowed to cool to 100° C. and were discharged. The resulting material appeared as a white solid. The properties of the oxidized AlphaPlus® C30+HA are provided in Table 2.

### Example 8

AlphaPlus® C26-28 (Chevron Phillips Chemical Company LP), 500 g, was placed into a four-neck flask equipped with a heating mantle, a thermocouple, a single blade agitator, an air sparger (cylindrical, 1″ in length and ⅜″ in diameter, average pore size 15 μm), and a side arm connected to a receiving flask. The wax was heated to 145° C. and the agitation was set at 400 rpm. Then a steady stream of air was introduced at 3.4 ft³/hr. The reaction was maintained at 145° C. for 24 hours. The contents were allowed to cool to 100° C. and were discharged. The resulting material appeared as a white solid. The properties of the oxidized AlphaPlus® C26-28 are provided in Table 2.

### Example 9

AlphaPlus® C30+ (Chevron Phillips Chemical Company LP), 500 g, was placed into a four-neck flask equipped with a heating mantle, a thermocouple, a single blade agitator, an air sparger (cylindrical, 1″ in length and ⅜″ in diameter, average pore size 15 μm), and a side arm connected to a receiving flask. The wax was heated to 145° C. and then a steady stream of air was introduced at 3.4 ft³/hr. The reaction was maintained at temperature 145° C. for 24 hours. The contents were allowed to cool to 100° C. and were discharged. The resulting material appeared as a yellow solid. The properties of the oxidized AlphaPlus® C30+ are provided in Table 2.

### Example 10

AlphaPlus® C30+HA (Chevron Phillips Chemical Company LP), 500 g, was placed into a four-neck flask equipped with a heating mantle, a thermocouple, a single blade agitator, an air sparger (cylindrical, 1″ in length and ⅜″ in diameter, average pore size 15 μm), and a side arm connected to a receiving flask. The wax was heated to 145° C. and then a steady stream of air was introduced at 3.4 ft³/hr. The reaction was maintained at temperature 145° C. for 24 hours. The contents were allowed to cool to 100° C. and were discharged. The resulting material appeared as a yellow solid. The properties of the oxidized AlphaPlus® C30+HA are provided in Table 2.

### Example 11

AlphaPlus® C26-28 (Chevron Phillips Chemical Company LP), 500 g, was placed into a four-neck flask equipped with a heating mantle, a thermocouple, a single blade agitator, an air sparger (cylindrical, 1″ in length and ⅜″ in diameter, average pore size 15 μm), and a side arm connected to a receiving flask. The wax was heated to 145° C. and then a steady stream of air was introduced at 3.4 ft³/hr. The reaction was maintained at temperature 145° C. for 24 hours. The contents were allowed to cool to 100° C. and were discharged. The resulting material appeared as a yellow solid. The properties of the oxidized AlphaPlus® C26-28 are provided in Table 2.

### Example 12

AlphaPlus® C24-28 (Chevron Phillips Chemical Company LP), 500 g, was placed into a four-neck flask equipped with a heating mantle, a thermocouple, a single blade agitator, an air sparger (cylindrical, 1″ in length and ⅜″ in diameter, average pore size 15 μm), and a side arm connected to a receiving flask. The wax was heated to 145° C. and then a steady stream of air was introduced at 3.4 ft³/hr. The reaction was maintained at temperature 145° C. for 24 hours. The contents were allowed to cool to 100° C. and were discharged. The resulting material appeared as a yellow solid. The properties of the oxidized AlphaPlus® C24-28 are provided in Table 2.

### Example 13

AlphaPlus® C20-24 (Chevron Phillips Chemical Company LP), 500 g, was placed into a four-neck flask equipped with a heating mantle, a thermocouple, a single blade agitator, an air sparger (cylindrical, 1″ in length and ⅜″ in diameter, average pore size 15 μm), and a side arm connected to a receiving flask. The wax was heated to 145° C. and then a steady stream of air was introduced at 3.4 ft³/hr. The reaction was maintained at temperature 145° C. for 24 hours. The contents were allowed to cool to 100° C. and were discharged. The resulting material appeared as a yellow solid. The properties of the oxidized AlphaPlus® C20-24 are provided in Table 2.

TABLE 2
Normal Alpha Olefin Wax Oxidation Conditions and Properties of the Oxidized Normal Alpha Olefin Waxes for Examples 1-13.

| | | Oxidation Conditions | | | Oxidized Wax Properties | | | | |
|---|---|---|---|---|---|---|---|---|---|
| | | Temper- | | | Needle | Saponification | | Viscosity | Drop Melt |
| Exam- | | ature | Time | Flow Rate | Penetration | Number | Acid Number | at 100° C. | Point |
| ple | Feed Stock | (° C.) | (hours) | (CFU per kg) | (dmm) | (mg KOH per g) | (mg KOH per g) | (cSt) | (° C.) |
| 1 | AlphaPlus ® C30+ | 130 | 24 | 3.4 | 6 | 45 | 15 | 16.6 | 74 |
| 2 | AlphaPlus ® C30 + HA | 130 | 24 | 3.4 | 13 | 50 | 17 | 13.3 | 71 |
| 3 | AlphaPlus ® C30+ | 145 | 8 | 6.8 | 12 | 97 | 37 | 25 | 74 |
| 4 | AlphaPlus ® C30 + HA | 145 | 8 | 6.8 | 14 | 68 | 28 | 22.8 | 70 |
| 5 | AlphaPlus ® C26-28 | 145 | 8 | 6.8 | 33 | 91 | 40 | 15.5 | 60 |
| 6 | AlphaPlus ® C30+ | 145 | 24 | 6.8 | 20 | 150 | 46 | 70.5 | 70 |
| 7 | AlphaPlus ® C30 + HA | 145 | 24 | 6.8 | 14 | 136 | 44 | 65.9 | 68 |
| 8 | AlphaPlus ® C26-28 | 145 | 24 | 6.8 | 55 | 177 | 40 | 56.3 | 55 |
| 9 | AlphaPlus ® C30+ | 145 | 24 | 3.4 | — | — | 30.3 | — | — |
| 10 | AlphaPlus ® C30 + HA | 145 | 24 | 3.4 | — | — | 30.3 | — | — |
| 11 | AlphaPlus ® C26-28 | 145 | 24 | 3.4 | — | — | 39.8 | — | — |
| 12 | AlphaPlus ® C24-28 | 145 | 24 | 3.4 | 34 | 50 | 14 | — | — |
| 13 | AlphaPlus ® C20-24 | 145 | 24 | 3.4 | — | — | — | — | — |

### Example 14

AlphaPlus® C30+ (Chevron Phillips Chemical Company LP), 500 g, was placed into a four-neck flask equipped with a heating mantle, a thermocouple, a magnetic stirrer, an gas sparger (cylindrical, 1″ in length and ⅜″ in diameter, average pore size 15 μm), and a side arm connected to a receiving flask. The wax was heated to 145° C. and a stream of air was introduced at 3.4 cubic feet per hour into the flask. The oxidation reaction was maintained at 145° C. for 30 hours. The air supply through the gas sparger was replaced with nitrogen gas and the nitrogen flow was maintained at the same rate (3.4 cubic feet per hour) for two hours to substantially remove volatile compounds from the oxidized olefin.

After the nitrogen purging was completed and substantially all of the air was removed, calcium hydroxide (5.56 g, 0.6 wt % calcium in the final product) was added into the flask at 145° C. and the temperature maintained at 145° C. for 2 hours. The temperature was then raised to 180° C. and maintained at 180° C. for 2 hours to remove water. The contents in the flask were allowed to cool to 90° C. and the liquid wax composition was discharged.

The properties of the feedstock olefin wax, the oxidized olefin wax, and the odor-reduced oxidized olefin wax are summarized in Table 3. The odor-reduced oxidized olefin wax had much milder odor compared to the oxidized olefin wax (i.e., the oxidized wax without the addition of the odor-reducing material).

TABLE 3

| | | | Odor-Reduced |
|---|---|---|---|
| | Feedstock | Oxidized | Oxidized |
| Properties | Olefin Wax | Olefin Wax | Olefin Wax |
| Calcium Content | 0 | 0 | 0.6 wt % |
| Needle Penetration Number | 13 | 7.1 | 4.8 |
| at 25° C., mm | | | |
| (ASTM D1321) | | | |
| Saponification number, mg | <1 | 67 | 49 |
| KOH per g (ASTM D94) | | | |
| Acid Number, mg KOH | <1 | 15 | 4 |
| per g (ASTM D974) | | | |
| Melt Viscosity at 100° C., | 6.5 | 36 | 77 |
| cSt (ASTM D445) | | | |
| Drop melt point, ° F. | 166 | 170 | 175 |
| (ASTM D127) | | | |

Example 14 demonstrates that the odor-reduced oxidized olefin produced by adding the odor-reducing agent, calcium hydroxide, to the oxidized olefin wax, not only reduced the smell but also improved its hardness when compared to the oxidized olefin wax.

While embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the embodiments of the present invention. The discussion of a reference in application is not an admission that it is prior art to the present invention, especially any reference that can have a publication date after the priority date of this application. The disclosures of all patents, patent applications, and publications cited herein are hereby incorporated by reference, to the extent that they provide exemplary, procedural, or other details supplementary to those set forth herein.

What is claimed is:

1. A method comprising:
i) contacting an olefin wax with an oxidizing agent to produce an oxidized olefin wax;
ii) contacting the oxidized olefin wax with an odor-reducing material to produce an odor-reduced oxidized olefin wax; and
iii) removing water from the odor-reduced oxidized olefin wax.

2. The method of claim 1, wherein the olefin wax comprises one or more of the following:
a) greater than 90 wt % olefins having from 20 to 24 carbon atoms and greater than 75 mole % alpha olefins having from 20 to 24 carbon atoms;
b) greater than 70 wt % olefins having from 24 to 28 carbon atoms and greater than 45 mole % alpha olefins having from 24 to 28 carbon atoms;
c) greater than 90 wt % olefins having from 26 to 28 carbon atoms and greater than 75 mole % alpha olefins having from 26 to 28 carbon atoms;
d) greater than 80 wt % olefins having at least 30 carbon atoms and greater than 45 mole % alpha olefins having at least 30 carbon atoms; or
e) greater than 85 wt % olefins having at least 30 carbon atoms and greater than 75 mole % alpha olefins at least 30 carbon atoms.

3. The method of claim 1, wherein the oxidizing agent comprises an oxygen-containing gas.

4. The method of claim 3, wherein the oxygen-containing gas comprises pure oxygen, oxygen diluted with an inert gas, air, or air diluted with an inert gas.

5. The method of claim 1, wherein the oxidized olefin wax is produced under conditions capable of forming an oxidized olefin wax comprising a temperature between the olefin wax melting point and 300° C.

6. The method of claim 1, wherein the odor-reducing material comprises a metal hydroxide, a metal carbonate, a metal bicarbonate, a metal carboxylate, or any combination thereof.

7. The method of claim 6, wherein the metal of the odor-reducing material comprises a Group 2 metal.

8. The method of claim 1, wherein the odor-reducing material comprises calcium hydroxide, calcium carbonate, calcium bicarbonate, a calcium carboxylate, or any combination thereof.

9. The method of claim 8, wherein the odor-reducing material comprises calcium hydroxide.

10. The method of claim 1, wherein the odor-reduced oxidized olefin wax is produced under conditions capable of forming an odor-reduced oxidized alpha olefin wax.

11. The method of claim 1, wherein the odor-reduced oxidized olefin wax is produced under conditions capable of forming an odor-reduced oxidized olefin wax comprising the substantial absence of added water.

12. The method of claim 1, wherein the odor-reduced oxidized olefin wax is produced under conditions capable of forming an odor-reduced oxidized olefin wax comprising a temperature ranging from the oxidized olefin wax melting point to 300° C.

13. The method of claim 1, wherein an amount of odor-reducing material contacted with the oxidized olefin wax ranges from 5 to 1500 milliequivalents of odor-reducing material per acid number KOH equivalents per gram of oxidized olefin wax.

14. The method of claim 1, wherein the oxidized olefin wax has an acid number greater than 1 mg KOH per g oxidized olefin wax and a kinematic viscosity at 100° C. less than 70 cSt.

15. The method of claim 1, wherein the oxidized olefin wax has a needle penetration value at 25° C. at least 5 percent less than a needle penetration value at 25° C. of the olefin wax and a kinematic viscosity at 100° C. of up to about 500% greater than the kinematic viscosity of the olefin wax.

16. The method of claim 11, wherein the oxidized olefin wax has a drop melt point greater than the drop melt point of the olefin wax.

17. The method of claim 1, wherein the odor-reduced oxidized olefin wax has a 25° C. needle penetration less than the 25° C. needle penetration of the oxidized olefin wax.

18. The method of claim 1, wherein the odor-reduced oxidized olefin wax has a needle penetration value at 25° C. at least at least 10 percent less than a needle penetration value at 25° C. of the oxidized alpha olefin wax.

19. The method of claim 1, wherein the odor-reduced oxidized olefin wax has a 100° C. kinematic viscosity ranging from 5 cSt to 200 cSt.

20. The method of claim 1, wherein the odor-reduced oxidized olefin wax has a drop melt point greater than the drop melt point of the oxidized olefin wax.

21. A composition comprising a product of a mixture of an oxidized olefin wax and an odor-reducing material, wherein the needle penetration of the composition is less than the oxidized alpha olefin wax in the absence of the odor-reducing material.

22. The composition of claim 21, wherein the odor-reducing material comprises a metal hydroxide, a metal carbonate, a metal bicarbonate, a metal carboxylate, or any combination thereof.

23. The composition of claim 21, wherein the odor-reducing material comprises calcium hydroxide.

24. The composition of claim 21, wherein an amount of odor-reducing material present ranges from 5 to 1500 milliequivalents of odor-reducing material per acid number KOH equivalents per gram of oxidized olefin wax.

25. A method comprising:
i) contacting an olefin wax with an oxidizing agent to produce an oxidized olefin wax under conditions capable of forming an oxidized olefin wax comprising a temperature ranging from the olefin wax melting point to 300° C.;
ii) contacting the oxidized olefin wax with an odor-reducing material to produce an odor-reduced olefin wax under conditions capable of forming an oxidized olefin wax comprising a temperature ranging from the oxidized olefin wax melting point and 300° C.; and
iii) removing water from the odor-reduced oxidized olefin wax;
wherein the oxidized olefin wax has an acid number greater than 1 mg KOH per g oxidized olefin wax and a kinematic viscosity at 100° C. less than 70 cSt, and
wherein the odor-reduced oxidized olefin wax has a needle penetration less than the oxidized olefin wax in the absence of the odor-reducing material.
